(19) United States
(12) Patent Application Publication
(10) Pub. No.: US 2004/0024767 A1
(43) Pub. Date: Feb. 5, 2004

(54) Method and system for managing event information in a computer network

(76) Inventor: Dexing Chen, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/207,808

(22) Filed: Jul. 31, 2002

(51) Int. Cl. G06F 17/30

(52) U.S. Cl. 707/100

(57) ABSTRACT

A method and system are disclosed for managing event information in a computer network. In accordance with exemplary embodiments of the present invention, an occurrence of an event in the computer network is monitored. The computer network has at least one computer service information database and an event correlation database. The event correlation database contains information for correlating computer service information from the computer service information database with the event information. Upon the occurrence of the event, the event correlation database is used to automatically correlate the event information associated with the event with the computer service information associated with the event to generate correlated event information. The correlated event information associates with the event a computer service of at least one user affected by the occurrence of the event.

### BACKGROUND

1. Field of the Invention

The present invention relates to computer networks. More particularly, the present invention relates to a method and system for managing event information in a computer network.

2. Background Information

In conventional information technology (IT) service assurance, operators face significant technical challenges to quickly identify impacted computer services and customers, through, for example, associated service level agreements (SLAs), when an event in the computer network occurs, e.g., a computer database server goes down. The conventional process of identifying impacted customers of an event can involve numerous steps. For example, the operator receives an event notification, for example, a server goes down. In response to the event notification, the operator goes to, for example, another system for SLA information or a spreadsheet or other database of service and customer information. The operator then browses through these various information sources to determine those customers that are potentially impacted by the occurrence of the event.

The service and customer information can be stored in different systems, using multiple data sources, with each data source being a different data source type. For example, different customers may have their own proprietary repository or system for SLA information management. Thus, to identify impacted services and related SLAs or impacted customers when an event occurs, operators must associate the IT event with the SLA information from numerous, disperse information sources. Such a procedure significantly increases the time required for determining impacted computer services and customers. This increase in determination time negatively affects a computer service provider whose revenue stream consists of computer services delivered over a computer network.

### SUMMARY OF THE INVENTION

A method and system are disclosed for managing event information in a computer network. In accordance with exemplary embodiments of the present invention, an occurrence of an event in the computer network is monitored. The computer network has at least one computer service information database and an event correlation database. The event correlation database contains information for correlating computer service information from the computer service information database with the event information. Upon the occurrence of the event, the event correlation database is used to automatically correlate the event information associated with the event with the computer service information associated with the event to generate correlated event information. The correlated event information associates with the event a computer service of at least one user affected by the occurrence of the event.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a flowchart illustrating steps for managing event information in a computer network in accordance with an exemplary embodiment of the present invention.

FIG. 2 illustrates a system for managing event information in a computer network in accordance with an exemplary embodiment of the present invention.

### DETAILED DESCRIPTION OF THE PREFERRED EMBODIMENTS

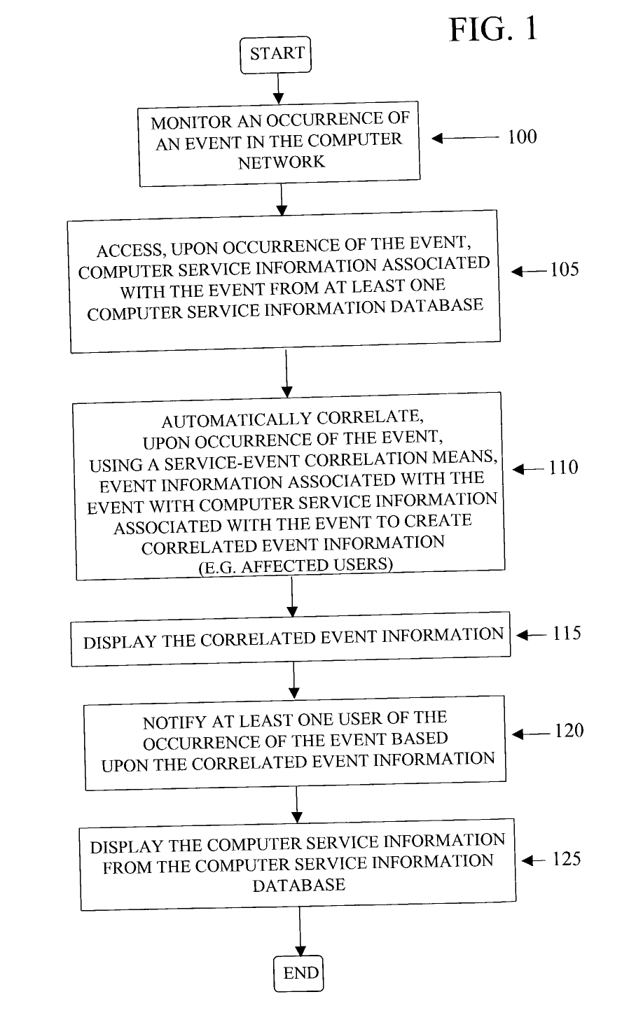

FIG. 1 is a flowchart illustrating the steps for managing event information in a computer network in accordance with an exemplary embodiment of the present invention. In step 100, an occurrence of an event is monitored in the computer network. As used herein, an “event” in the computer network can include any type of event or activity associated with the computer network. According to exemplary embodiments, event information is associated with an operability of the computer network. However, an event can include, but is not limited to, a computer (e.g., a computer server or any other type of computing system) or other computer network device (e.g., a switch, a router, etc.) in the computer network going down, a network connection going down, a degradation in computer, computer network device or computer network performance, an attack on the computer network (where an attack can include, for example, any unwanted intrusion or malicious activity into or on the computer network), or any other event or activity associated with a computer network.

The computer network can be any type of computer network or computer system on which events can be monitored. For example, the computer network can be a local area network (LAN), wide area network (WAN), any type of intranet or internet, an information technology (IT) management system, or any other type of computer network or computer system on which events can be monitored.

Occurrence of events in the computer network can be monitored using any type of computer software or computer/electronic system that is capable of monitoring event information in a computer system or computer network. For example, the OpenView™ Operations (OVO) Management Server offered by Hewlett-Packard Company (Palo Alto, Calif.) is an example of such a monitoring system. OVO is a distributed client/server software solution designed to assist system administrators in the detection, solution, and prevention of problems occurring in computer networks, systems and applications in any enterprise. OVO captures all network and server events in a multi-tiered hierarchical database.

To provide additional event information to OVO, for example, the OpenView™ Internet Services (OVIS) offered by Hewlett-Packard Company can be used. OVIS extends Simple Network Management (SNMP) based monitoring of network devices to simulation-based monitoring of both network devices and co-located servers. SNMP is a set of protocols for managing complex networks. SNMP works by sending messages, called protocol data units (PDUs), to different parts of a network. SNMP-compliant devices, called agents, store data about themselves in Management Information Bases (MIBs) and return this data to the SNMP requesters.

For OVIS, no agent software is required on the monitored devices or systems. Checks are made on a regular basis on the availability and performance of routers, switches, modem banks, etc., using Internet Control Message Protocol (ICMP) and DIALUP requests, and of standard Internet services using requests such as NNTP (Network News Transfer Protocol), FTP (File Transfer Protocol), SMTP (Simple Mail Transfer Protocol), POP3 (Post Office Protocol), DNS (Domain Name Service), WAP (Wireless Application Protocol), etc. OVIS actively probes availability and response time of network-related services and Internet-related services. The systems running the OVIS service probes feed the OVIS probe data back to the OVIS measurement server, which can forward the information to, for example, the OVO management server. Although the foregoing is an illustration of an exemplary embodiment for monitoring the occurrence of an event in the computer network, any event monitoring computer system or software can be used to monitor the occurrence of events in the computer network in accordance with exemplary embodiments of the present invention.

According to exemplary embodiments, the computer network has at least one According to exemplary embodiments, the computer network has at least one computer service information database. As used herein, “computer service information” is any type of information that provides information on the computer services associated with users in the computer network. According to exemplary embodiments, computer service information includes, but is not limited to, service level agreement information. A Service Level Agreement (SLA) is a contract between a service provider (network, application, etc.) and a customer that specifies, usually in measurable terms, what services the service provider will furnish. For example, Internet service providers (ISP)s provide their customers with an SLA; also IS departments in major enterprises often write an SLA so that services for their customers (users in other departments within the enterprise) can be measured, justified, and perhaps compared with those of outsourcing network providers. Application Service Providers can be third-party entities that manage and distribute software-based services and solutions to customers across, for example, a wide area network from a central data center.

A SLA can include, for example, the name of the organization and/or individual receiving the service, the name of the organization providing the service, the specified level of service, support options, enforcement or penalty provisions for services not provided, a guaranteed level of system performance as relates to downtime or uptime, a specified level of customer support, the software or hardware that will be provided and for what fee, or any other type of information that is associated with computer services offered to users. According to exemplary embodiments, computer service information can also include a service level of a service level agreement, a name of a computer service provider, a name of a computer service receiver (e.g., a customer or user name), a name of a computer service support operator, a computer service, or any other type of information associated with the computer services that can be offered to, and used by, users of the computer network.

As used herein, a “computer service information database” is any collection of computer service information that is organized and stored in any type of electronic storage medium. For example, a computer service information database can be any type of computer database (e.g., a structured query language (SQL) database), application system (e.g., a database management system), a spreadsheet, plain text, or any other type of electronic collection of information. For example, the OpenView™ Service Desk (OVSD) offered by Hewlett-Packard Company can be used to organize and store computer service information. OVSD demonstrates the relationships between customers, business services, service level agreements and support level objectives. However, any collection of information in any type of electronic storage medium in which computer service information can be organized and stored can be used.

The data type(s) and format of the information contained in the at least one computer service information database can be different data source types. For example, the computer service information stored in a computer service information database can be in XML (Extensible Markup Language) format, HTML (HyperText Markup Language) format, SGML (Standard Generalized Markup Language) format, plain text, a proprietary binary format, or any other data source type that can be used to store computer service information in a computer service information database. Exemplary embodiments of the present invention can support multiple and different data sources and data source types of computer service information.

In step 105 of FIG. 1, upon occurrence of the event, the computer service information associated with the event is accessed from the at least one computer service information database using an event correlation database. According to exemplary embodiments, the user can specify the at least one computer service information database to access for computer service information. The user can specify any number or combination of computer service information databases from which to access the information. If no such database is specified by the user, a default database can be used. The specification of the database(s) by the user can be stored in, for example, a configuration information database. The configuration information database is any collection of configuration information that is organized and stored in any type of electronic storage medium. The configuration information is any information that can be used to configure any aspect of exemplary embodiments of the present invention.

According to exemplary embodiments, the user can specify the computer service information in the at least one computer service information database to correlate with the event information upon the occurrence of the event. For example, the user can specify the computer services or SLAs that are associated with a particular computer server or computer network device, although the user can specify any type of computer service information to correlate with the event information. The specification, by the user, of the computer service information to correlate with the event information thereby associates the computer service information with the event information.

According to exemplary embodiments, the association of computer service information with event information can be maintained in an event correlation database. According to exemplary embodiments, the computer network has at least one event correlation database. As used herein, an “event correlation database” is any collection of information that is organized and stored in any type of electronic storage medium that can be used for correlating computer service information from the computer service information database with the event information. For example, a hierarchical data structure or any other type of information record can be used to define the relationship between computer service information and event information. These data structures can be stored in, for example, the event correlation database.

According to exemplary embodiments, the occurrence of the event generates associated event information, for example, a warning or error message, an alarm, or any other type of indication or description that an event has occurred in the computer network. The event information can include, for example, the location of the event, a description of the event, a severity level of the event, or any other description or specification of the event that occurred in the computer network. Upon occurrence of the event, exemplary embodiments of the present invention use the event information to access or otherwise retrieve the computer service information from the computer service information database associated with the event using the event correlation database.

For example, the event information can include the source node of the event (e.g., a name of a computer server that failed). The event correlation database can specify the computer service information associated with each source node. For example, the event correlation database can specify that SLAs for users that are associated with the particular source node that failed. According to exemplary embodiments, the source node of the event can be used to retrieve from the event correlation database any or all computer service information associated with the source node of the event. However, any aspect or attribute of the event information can be used to access or otherwise retrieve the computer service information associated with the event from the at least one computer service information using the event correlation database. Once the computer service information associated with the event is determined using the event correlation database, the appropriate computer service information can be retrieved from the at least one computer service information database, for example, the database(s) specified by the user.

In step 110, upon occurrence of the event, the event correlation database is used to automatically correlate the event information with the computer service information associated with the event to generate correlated event information. The correlated event information associates with the event a computer service of at least one user affected by the occurrence of the event. As used herein, to “correlate” pieces of information is to establish a relationship between the pieces of information. According to exemplary embodiments, to correlate the event information and the computer service information is to establish a relationship between the event information and the computer service information. For example, the event information can be associated with the computer service information, or the event information and the computer service information can be combined to form a new, merged piece of information. However, any form of relationship can be established between the event information and the computer service information associated with the event when a correlation is performed.

According to exemplary embodiments, the event information is correlated with the computer service information associated with the event using at least one computer service attribute associated with the event information. Thus, exemplary embodiments of the present invention use computer service attributes to enrich or otherwise modify the event information with the computer services of users affected by the event. The correlated event information can include, therefore, both the event information and the associated computer service information, the event information and a reference or other type of link to the associated computer service information, or any other form of relationship between the event information and the computer service information.

According to exemplary embodiments, the at least one computer service attribute can be any information associated with a computer service. For example, at least one computer service attribute includes a name of a service level agreement, a service level of a service level agreement, a name of a computer service provider, a name of a computer service receiver, a name of a computer service support operator, or any other computer service information that describes or otherwise indicates a computer service associated with the event.

According to an exemplary embodiment, OVO management server can be used to correlate the event information with the computer service information associated with the event using at least one computer service attribute associated with the event information. For example, OVO management server has a feature called Customer Message Attributes (CMA). CMA allows users to modify the content of a message by allowing supplemental fields to be added with additional content. OVO's message stream interface (MSI) can be used to set CMA attributes for potential impacted services to generate an OVO MSI message that has been enriched or otherwise modified with computer service information. For example, OVO MSI can be used to intercept a specified event and add computer service information content to the event in the form of a CMA.

Thus, according to an exemplary embodiment, the computer service information associated with the event, that has been retrieved from the computer service information database, can be included in the OVO MSI messages as CMA fields to generate a new OVO MSI message with additional CMA fields as the correlated event information. However, any event correlation database can be used to automatically correlate the event information associated with the event with the computer service information associated with the event to generate correlated event information.

In step 115, the correlated event information is displayed. The correlated event information can be displayed using any computer monitor or any other video display device for displaying graphical and/or textual information to a user. The correlated event information can be displayed on the video display device using, for example, a Web browser, such as, for example, Netscape Navigator™ or Microsoft Internet Explorer™, or any other type of graphical browser or graphical user interface through which graphical and/or textual information can be displayed to a user.

According to exemplary embodiments, the user can specify the format of the displayed correlated event information. The display format information can be stored in and retrieved from, for example, the configuration information database. For example, according to an exemplary embodiment, the new OVO MSI message that has been generated with additional CMA fields—the correlated event information—can be displayed in an OVO Java console message browser. An OVO Java console message browser is a graphical user interface that displays to the user all event information associated with events that have occurred in the computer network. According to an exemplary embodiment, the OVO Java console message browser can be modified to display the original event information message and the additional computer service information, included in the CMA fields, that has been correlated with the event information. Thus, a user is able to view both the information associated with the event and the computer services of at least one user affected by the occurrence of the event. However, the correlated event information can be displayed using any type of video display device using any graphical display format.

Exemplary embodiments of the present invention can support multiple and different data sources and data source types of computer service information for generating the correlated event information. To allow the user to specify the format of the displayed correlated event information, exemplary embodiments of the present invention can translate or otherwise transform the data type of the computer service information as it is accessed from the computer service information databases into a uniform data type or format.

For example, the data type of the computer service information can be converted into XML files and XML Document Object Model (DOM) documents. XML provides a universal format for describing structured documents and data that offers greater flexibility in transferring data between different applications on different platforms and machines. The Document Object Model (DOM) is a platform- and language-neutral application programming interface (API) for HTML and XML documents. XML DOM is used to manipulate the XML files. XML DOM defines the logical structure of documents and the way a document is accessed and manipulated. With the DOM, a user can build documents, navigate their structure, and add, modify, or delete elements and content. Anything found in an HTML or XML document can be accessed, changed, deleted, or added using the DOM.

Thus, by converting the information accessed from the computer service information databases into a uniform format, such as XML or any other universal or uniform data type and format, that can be manipulated by a platform- and language-neutral interface such as XML DOM, the user can specify the format, layout, structure or any other display feature or characteristic of the correlated event information by modifying the XML DOM used for displaying the correlated event information. However, any uniform data format and any platform- and language-neutral API for manipulating the uniform data format can be used for displaying the correlated event information.

In step 120, at least one user is notified of the occurrence of the event based upon the correlated event information. According to exemplary embodiments, the correlated event information associates the event information and a computer service of at least one user affected by the occurrence of the event. Consequently, the at least one user affected by the event can be identified from the correlated event information. For example, a system administrator can use the displayed correlated event information to manually contact the users affected by the occurrence of the event, for example, by telephone, e-mail, regular mail, or any other means by which a user can be contacted manually.

Alternatively, the correlated event information can be used to automatically notify the users affected by the occurrence of the event, for example, by automatic generation of an e-mail message, an alert or alarm message sent to the user at a predetermined location, or any other means by which a user can be automatically notified of the occurrence of an event. Thus, using the correlated event information, the at least one user can be notified of the occurrence of the event using the correlated event information and any manual or automatic, digital or analog means, via any type of transmission medium capable of carrying information, to contact or otherwise notify the at least one user.

In step 125, the computer service information is displayed from the computer service information database. According to exemplary embodiments, the computer service of the at least one user affected by the occurrence of the event that is included in the correlated event information can be used to access more detailed information from the computer service information databases. For example, the computer service information included in the correlated event information can be a summary of the computer service affected by the occurrence of the event, a subset of the computer service information associated with the event, or any other initial computer service information from which a user is able to discern the nature of the computer services affected by the occurrence of the event. From this information, a user (e.g., a system administrator) can access the computer service information database to retrieve additional information corresponding to the summary information.

According to an exemplary embodiment, if the correlated event information is displayed in, for example, a Web browser or any other type of graphical browser or user interface, the user can click or otherwise select the correlated event information using any type of computer pointing device (e.g., a mouse). The selection by the user can, for example, bring up another window within the display with the corresponding detailed computer service information from the computer service information database. For example, the detailed computer service information can be the corresponding service level management information of the users affected by the event, such as, for example, the name of the SLAs affected, the service of the SLA, the level of the SLA, the name of the service receiving organization, the name of the service receiving individual, the name of the service providing organization, or any other computer service information that is associated with the user. Alternatively, the detailed computer service information can be automatically displayed to the user without any intervention from the user. Thus, any computer service information from the computer service information database can be displayed to the user, whether manually by request from the user or automatically, upon occurrence of the event.

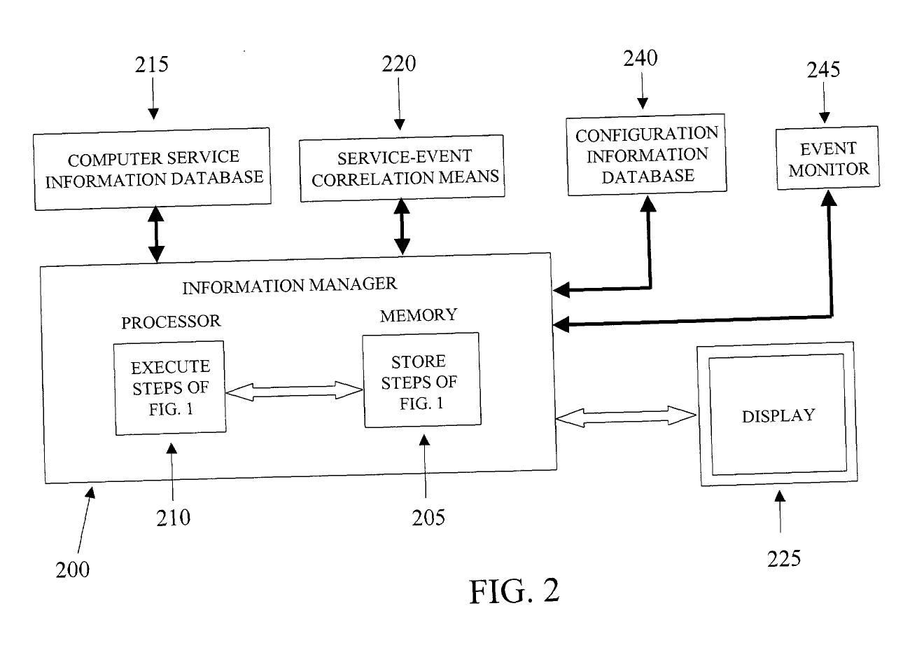

A system for managing event information in a computer network in accordance with exemplary embodiments of the present invention is illustrated in FIG. 2. The system includes at least one computer service information database 215 for storing computer service information. Computer service information database 215 can be any collection of computer service information that is organized and stored in any type of electronic storage medium. For example, OVSD can be used to organize and store computer service information, although any electronic storage medium capable of organizing and storing computer service information can be used.

According to exemplary embodiments, computer service information stored in computer service information database 215 includes, but is not limited to, service level agreement information. According to exemplary embodiments, the computer service information can also include a service level of a service level agreement, a name of a computer service provider, a name of a computer service receiver (e.g., a customer or user name), a name of a computer service support operator, a computer service, or any other information associated with the computer services that can be offered to, and used by, users of the computer network.

The data type(s) and format of the information contained in the at least one computer service information database can be different data source types. For example, the computer service information stored in computer service information database 215 can be in XML (Extensible Markup Language) format, HTML (HyperText Markup Language) format, SGML (Standard Generalized Markup Language) format, plain text, a proprietary binary format, or any other data source type that can be used to store computer service information in computer service information database 215. Exemplary embodiments of the present invention can support multiple and different data sources and data source types of computer service information.

The system includes an event correlation database 220. Event correlation database 220 contains information for correlating computer service information from the computer service information database with the event information. Event correlation database 220 is any collection of information that is organized and stored in any type of electronic storage medium that can be used for correlating computer service information from the computer service information database with the event information. For example, a hierarchical data structure or any other type of information record can be used to define the relationship between computer service information and event information. These data structures can be stored in, for example, event correlation database 220.

The system includes an information manager 200. Information manager 200 can be implemented using any combination of hardware, firmware or software. According to exemplary embodiments, information manager 200 can be, for example, a computer, such as a personal computer or any other computing system. Information manager 200 includes a memory 205. Memory 205 can be any computer memory or any other type of electronic storage medium that is located either internally or externally to information manager 200. Memory 205 can store, for example, the steps of a computer program as illustrated in FIG. 1. As will be appreciated based on the foregoing description, memory 205 can be programmed using conventional techniques known to those having ordinary skill in the art of computer programming to carry out the steps of a computer program as illustrated in FIG. 1. The actual source code or object code for carrying out the steps of a computer program as illustrated in FIG. 1 can be stored in memory 205.

Memory 205 stores steps of a computer program to monitor an occurrence of an event in a computer network. According to exemplary embodiments, event information is associated with an operability of the computer network. However, an event can be any event or activity associated with a computer network. The system can include an event monitor 245 for monitoring the occurrence of events in the computer network. Event monitor 245 can be any type of computer software or computer/electronic system that is capable of monitoring event information in a computer system or computer network. For example, the OVO Management Server in combination with OVIS can be used as event monitor 245. However, any event monitoring computer system or software can be used as event monitor 245 to monitor the occurrence of events in the computer network in accordance with exemplary embodiments of the present invention.

Memory 205 can store the steps of a computer program to access, upon the occurrence of the event, the computer service information associated with the event from the at least one computer service information database using the event correlation database. Upon occurrence of the event, exemplary embodiments of the present invention use the event information to access or otherwise retrieve the computer service information from the computer service information database associated with the event using the event correlation database. For example, the event information can include the source node of the event (e.g., a name of a computer server that failed). The event correlation database can specify the computer service information associated with each source node. According to exemplary embodiments, the source node of the event can be used to retrieve from the event correlation database any or all computer service information associated with the source node of the event. However, any information component of the event information can be used to access or otherwise retrieve the computer service information associated with the event from the at least one computer service information database using the event correlation database. Once the computer service information associated with the event is determined using the event correlation database, the corresponding computer service information can be retrieved from the at least one computer service information database.

According to exemplary embodiments, the user can specify the at least one computer service information database to access for computer service information. The user can specify any number or combination of computer service information databases from which to access the information. If no such database is specified by the user, a default database can be used. The specification of the database(s) by the user can be stored in, for example, a configuration information database 240. Configuration information database 240 is any collection of configuration information that is organized and stored in any type of electronic storage medium. The configuration information is any information that can be used to configure any aspect of exemplary embodiments of the present invention. The user specification of database(s) can be retrieved by or transmitted to information manager 200. Information manager 200 uses the database specification to determine which computer service information database(s) to access for computer service information. Thus, memory 205 can store the steps of a computer program to receive a database notification of the at least one computer service information database to access for computer service information.

According to exemplary embodiments, the user can specify the computer service information in the at least one computer service information database to correlate with the event information upon the occurrence of the event. For example, the user can specify the computer services or SLAs that are associated with a particular computer server or computer network device, although the user can specify any type of computer service information to correlate with the event information. The specification, by the user, of the computer service information to correlate with the event information thereby associates the computer service information with the event information. The user specification of the computer service information can be stored, for example, in event correlation database 220. The user specification of the computer service information can be retrieved by or transmitted to information manager 200. Information manager 200 uses the computer service information specification in the correlation of the computer service information with the event information. Thus, memory 205 can store the steps of a computer program to receive an information notification of the computer service information in the at least one computer service information database to correlate with the event information upon the occurrence of the event.

Memory 205 can store the steps of a computer program to automatically correlate, upon the occurrence of the event, using the event correlation database, the event information associated with the event with the computer service information associated with the event to generate correlated event information. The correlated event information associates with the event a computer service of at least one user affected by the occurrence of the event.

Memory 205 stores the steps of a computer program to correlate the event information with the computer service information associated with the event using at least one computer service attribute associated with the event information. Exemplary embodiments of the present invention use computer service attributes to augment or otherwise modify the event information with the computer service information of users affected by the event. According to exemplary embodiments, the at least one computer service attribute can be any information associated with a computer service. For example, at least one computer service attribute includes a name of a service level agreement, a service level of a service level agreement, a name of a computer service provider, a name of a computer service receiver, a name of a computer service support operator, or any other computer service information that describes or otherwise indicates a computer service associated with the event.

The system can include a display 225 for displaying the correlated event information from information manager 200. Display 225 can be any computer monitor or any other video display device for displaying graphical and/or textual information to a user. The correlated event information can be displayed on display 225 using, for example, a Web browser, such as, for example, Netscape Navigator™ or Microsoft Internet Explorer™, or any other type of graphical browser or graphical user interface through which graphical and/or textual information can be displayed to a user. According to exemplary embodiments, a user can view both the information associated with the event and the computer services of at least one user affected by the occurrence of the event. However, the correlated event information can be displayed using any type of video display device using any graphical display format.

According to exemplary embodiments, the user can specify the format of the displayed correlated event information. The display format information can be stored in and retrieved from, for example, configuration database 240 by information manager 200. Thus, memory 205 stores the steps of a computer program to receive a format notification of the format of the correlated event information for display. Exemplary embodiments of the present invention can support multiple and different data sources and data source types of computer service information for generating the correlated event information. To allow the user to specify the format of the displayed correlated event information, exemplary embodiments of the present invention can translate or otherwise transform the data type of the computer service information as it is accessed from the computer service information databases into a uniform data type or format. For example, the data type of the computer service information can be converted into XML files and XML DOM documents. However, any uniform data format and any platform- and language-neutral API for manipulating the universal data format can be used for displaying the correlated event information.

Memory 205 stores steps of a computer program to notify the at least one user of the occurrence of the event based upon the correlated event information. According to exemplary embodiments, the at least one user affected by the event can be identified from the correlated event information. For example, a system administrator can use the displayed correlated event information to manually contact the users affected by the occurrence of the event, for example, by telephone, e-mail, regular mail, or any other means by which a user can be contacted manually. Alternatively, the correlated event information can be used to automatically notify the users affected by the occurrence of the event, for example, by automatic generation of an e-mail message, an alert or alarm message sent to the user at a predetermined location, or any other means by which a user can be automatically notified of the occurrence of an event. Thus, using the correlated event information, the at least one user can be notified of the occurrence of the event using the correlated event information using any manual or automatic, digital or analog means, via any type of transmission medium capable of carrying information, to contact or otherwise notify the at least one user. L00501 Display 225 can display the computer service information from the computer service information database. According to exemplary embodiments, the computer service information that is included in the correlated event information can be used to access more detailed information from the computer service information databases. For example, the computer service information included in the correlated event information can be a summary of the computer service affected by the occurrence of the event, a subset of the computer service information associated with the event, or any other initial computer service information from which a user is able to discern the nature of the computer services affected by the occurrence of the event. From this information, a user (e.g., a system administrator) can access the computer service information database to retrieve additional information corresponding to the summary information.

According to an exemplary embodiment, if the correlated event information is displayed in, for example, a Web browser or any other type of graphical browser or user interface, the user can click or otherwise select the correlated event information using any type of computer pointing device (e.g., a mouse). The selection by the user can, for example, bring up another window within the display with the corresponding detailed computer service information from the computer service information database. Alternatively, the computer service information can be automatically displayed to the user without any intervention from the user. Thus, any computer service information from the computer service information database can be displayed to the user, whether manually by request from the user or automatically, upon occurrence of the event.

The system includes a means for accessing memory 205 to execute the computer program as illustrated in FIG. 1. The means for accessing can be, for example, a processor 210. Processor 210 can be any known processor, such as, for example, a microprocessor. However, the means for accessing can be any combination of hardware, firmware or software.

Each of computer service information database 215, event correlation database 220, configuration information database 240 and event monitor 245 can reside either internally to or externally from information manager 200. If externally, each of computer service information database 215, event correlation database 220, configuration information database 240 and event monitor 245 can be connected to information manager 200 using any form of electrical connection that is capable of transmitting and receiving electrical information. Information can be exchanged between information manager 200 and each of computer service information database 215, event correlation database 220, configuration information database 240 and event monitor 245 using any form of communication protocol that is capable of communicating electronic information through an electrical transmission medium. For example, the Simple Object Access Protocol (SOAP) can be used for exchanging information. SOAP is a lightweight, XML-based protocol for exchanging information in a decentralized, distributed environment. However, any communications protocol can be used.

Any or all of computer service information database 215, event correlation database 220, configuration information database 240, event monitor 245 and information manager 200 can be connected to at least one other computer in the computer network using any form of network connection, such as, for example, an Ethernet connection.

The steps of a computer program as illustrated in FIG. 1 for managing event information in a computer network can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for managing event information in a computer network, comprising:
monitoring an occurrence of an event in the computer network,
wherein the computer network has at least one computer service information database and an event correlation database,
wherein the event correlation database contains information for correlating computer service information from the computer service information database with the event information; and
automatically correlating, upon the occurrence of the event, using the event correlation database, the event information associated with the event with the computer service information associated with the event to generate correlated event information,
wherein the correlated event information associates with the event a computer service of at least one user affected by the occurrence of the event.

2. The method of claim 1, comprising:
accessing, upon the occurrence of the event, the computer service information associated with the event from the at least one computer service information database using the event correlation database.

3. The method of claim 1, comprising:
displaying the correlated event information.

4. The method of claim 1, comprising:
notifying the at least one user of the occurrence of the event based upon the correlated event information.

5. The method of claim 1, comprising:
displaying the computer service information from the computer service information database.

6. The method of claim 1, wherein the user specifies the at least one computer service information database to access for computer service information.

7. The method of claim 1, wherein the user specifies the computer service information in the at least one computer service information database to correlate with the event information upon the occurrence of the event.

8. The method of claim 4, wherein the user specifies the format of the displayed correlated event information.

9. The method of claim 1, wherein the computer service information includes service level agreement information.

10. The method of claim 1, wherein the event information is associated with an operability of the computer network.

11. The method of claim 1, wherein the event information is correlated with the computer service information associated with the event using at least one computer service attribute associated with the event information.

12. The method of claim 11, wherein the at least one computer service attribute includes at least one of: a name of a service level agreement, a service level of the service level agreement, a name of a computer service provider, a name of a computer service receiver; and a name of a computer service support operator.

13. A system for managing event information in a computer network, comprising:
at least one computer service information database for storing computer service information;
an event correlation database, wherein the event correlation database contains information for correlating computer service information from the computer service information database with the event information; and
an information manager, comprising:
a memory that stores the steps of a computer program to:
monitor an occurrence of an event in the computer network, and
automatically correlate, upon the occurrence of the event, using the event correlation database, the event information associated with the event with the computer service information associated with the event to generate correlated event information, wherein the correlated event information associates with the event a computer service of at least one user affected by the occurrence of the event; and
means for accessing the memory to execute the computer program.

14. The system of claim 13, wherein the memory of the information manager stores steps of a computer program to:
access, upon the occurrence of the event, the computer service information associated with the event from the at least one computer service information database using the event correlation database.

15. The system of claim 13, wherein the memory of the information manager stores steps of a computer program to:
notify the at least one user of the occurrence of the event based upon the correlated event information.

16. The system of claim 13, comprising:
a display for displaying the correlated event information from the information manager.

17. The system of claim 16, wherein the display displays the computer service information from the computer service information database.

18. The system of claim 13, wherein the memory of the information manager stores steps of a computer program to:
receive a database notification of the at least one computer service information database to access for computer service information.

19. The system of claim 18, wherein the memory of the information manager stores steps of a computer program to:
receive an information notification of the computer service information in the at least one computer service information database to correlate with the event information upon the occurrence of the event.

20. The system of claim 18, wherein the memory of the information manager stores steps of a computer program to:
receive a format notification of the format of the correlated event information for display.

21. The system of claim 13, wherein the computer service information includes service level agreement information.

22. The system of claim 13, wherein the event information is associated with an operability of the computer network.

23. The system of claim 13, wherein the memory of the information manager stores steps of a computer program to:
correlate the event information with the computer service information associated with the event using at least one computer service attribute associated with the event information.

24. The system of claim 23, wherein the at least one computer service attribute includes at least one of name of a service level agreement, a service level of the service level agreement, a name of a computer service provider, a name of a computer service receiver, and a name of a computer service support operator.

25. A computer-readable medium containing a computer program for managing event information in a computer network, wherein the computer program performs the steps of:
monitoring an occurrence of an event in the computer network,
wherein the computer network has at least one computer service information database and an event correlation database,
wherein the event correlation database contains information for correlating computer service information from the computer service information database with the event information; and
automatically correlating, upon the occurrence of the event, using the event correlation database, the event information with the computer service information associated with the event to generate correlated event information,
wherein the correlated event information associates with the event a computer service of at least one user affected by the occurrence of the event.

26. The computer-readable medium of claim 25, wherein the computer program performs the step of:
accessing, upon the occurrence of the event, the computer service information associated with the event from the at least one computer service information database using the event correlation database.

27. The computer-readable medium of claim 25, wherein the computer program performs the step of:
notifying the at least one user of the occurrence of the event based upon the correlated event information.

28. The computer-readable medium of claim 25, wherein the computer program performs the step of:
displaying the correlated event information.

29. The computer-readable medium of claim 25, wherein the computer program performs the step of:
displaying the computer service information from the computer service information database.

30. The computer-readable medium of claim 25, wherein the computer program receives a database notification of the at least one computer service information database to access for computer service information.

31. The computer-readable medium of claim 25, wherein the computer program receives an information notification of the computer service information in the at least one computer service information database to correlate with the event information upon the occurrence of the event.

32. The computer-readable medium of claim 28, wherein the computer program receives a format notification of the format of the displayed correlated event information.

33. The computer-readable medium of claim 25, wherein the computer service information includes service level agreement information.

34. The computer-readable medium of claim 25, wherein the event information is associated with an operability of the computer network.

35. The computer-readable medium of claim 25, wherein the event information is correlated with the computer service information associated with the event using at least one computer service attribute associated with the event information.

36. The computer-readable medium of claim 35, wherein the at least one computer service attribute includes at least one of: a name of a service level agreement, a service level of the service level agreement, a name of a computer service provider, a name of a computer service receiver, and a name of a computer service support operator.
